(19) United States
(12) Patent Application Publication
(10) Pub. No.: US 2025/0269516 A1
(43) Pub. Date: Aug. 28, 2025

(54) COMPACT INTERNALLY-ACTUATED CABLE-DRIVEN PARALLEL ROBOT

(71) Applicant: Dubai Future Foundation, Dubai (AE)

(72) Inventors: Yahya Al Hajj, Dubai (AE); Omar AlHammadi, Dubai (AE); Omar Elgouhary, Dubai (AE); Ahmad AlAttar, Dubai (AE); Tanzim Ahmed, Dubai (AE); Tarek Taha, Dubai (AE)

(73) Assignee: Dubai Future Foundation, Dubai (AE)

(21) Appl. No.: 19/059,851

(22) Filed: Feb. 21, 2025

Related U.S. Application Data
(60) Provisional application No. 63/556,627, filed on Feb. 22, 2024.

(51) Int. Cl. B25J 9/00; B25J 19/00

(52) U.S. Cl. CPC B25J 9/0078; B25J 19/005

(57) ABSTRACT

Compact, multi-level cable-driven devices and systems for performing surface operations. The device comprises a structural frame, one or more cable actuation systems arranged on a first elevation level of the structural frame, and one or more cable actuation systems arranged on a second elevation level of the structural frame. Each cable actuation system is configured to be coupled to a respective cable, the respective cable is configured to be removably connected to different positions on a work surface such that the device can move on the work surface by adjusting the length of the one or more cables.

### CROSS-REFERNCE TO RELATED APPLICATIONS

The present disclosure claims priority to and benefit of U.S. provisional patent application No. 63/556,627, entitled COMPACT INTERNALLY-ACTUATED CABLE-DRIVEN PARALLEL ROBOT, filed on Feb. 22, 2024, the entirety of which is hereby incorporated by reference herein.

### TECHNICAL FIELD

The present disclosure relates to cable driven devices and systems for performing surface operations, and in particular to compact internally-actuated cable driven robotic devices and systems.

### BACKGROUND

Skyscrapers and other large buildings with tall or unique shapes require continuous maintenance and cleaning due to various environmental and weather conditions. In some cases, for example, spaces that are restrictive or small, these buildings are cleaned manually by workers that are secured to the building or to other devices attached to or near the building. This can be dangerous for the workers and can be time consuming.

Robotic devices have been proposed for maintaining the surfaces and spaces of these buildings. There are some cable driven robotic systems, suction based robotic systems and aerial robotic systems that are normally manually operated. Some of these systems are autonomous, however these systems can be difficult and time consuming to set-up in smaller and more restrictive spaces.

Typically, existing systems can only be used on planar surfaces and can be slow to clean the windows. The existing robotic systems rely on gravity or planar surfaces to clean the windows. They cannot be used for irregular surfaces such as curved surfaces or surfaces with complex geometries. Some robotic systems may also be large in size, which would leave a larger footprint. Larger robotics systems may also be more difficult to transport, deploy, and operate. For example, it would be difficult to deploy a large robotic system in cramped and restrictive spaces.

Accordingly, an additional, alternative, and/or improved robotic system with a compact design for performing surface operations on building is desired.

### SUMMARY

In accordance with one aspect of the present disclosure, a cable-driven device is disclosed, comprising: a structural frame; one or more cable actuation systems arranged on a first elevation level of the structural frame; one or more cable actuation systems arranged on a second elevation level of the structural frame; wherein each of the first and second cable-actuation system is configured to be coupled to a respective cable, and wherein the respective cable is configured to be removably connected to different positions on a work surface.

In some aspects, the device, further comprises a plurality of cables, each of the plurality of cables respectively coupled to one of the one or more cable actuation systems.

In some aspects, a length between each of the one or more cable actuation systems and a connection point of each respective cable is automatically adjustable and a tension in each respective cable is maintained to move the cable-driven device on the surface.

In some aspects, the one or more cable-actuation systems are configured to automatically adjust a length of each respective cable between the body and a respective connection point.

In some aspects, the device further comprises a cleaning attachment in contact with the work surface to clean the work surface.

In some aspects, the device further comprises circuitry configured to: automatically adjust the length between the respective cables and the cable-driven device to move the cable-driven device on the work surface; and maintain the tension in the respective cables to maintain contact of the cable-driven device on the work surface.

In some aspects, the one or more cable actuation systems is a plurality of cable actuation systems, and the cable-driven device comprises two first cable actuation systems arranged on the first elevation level and two second cable actuation systems arranged on the second elevation level.

In some aspects, the each of the two first and second cable actuation systems is oriented between 150° to 210° with respect to another cable actuation system of a same elevation level and configured to receive cables from substantially opposing directions.

In some aspects, the two first cable actuation systems are oriented between 60° to 120° with respect to the two second cable actuation systems along a plane defined by the first elevation level.

In some aspects, the two first cable actuation systems are oriented substantially orthogonally with respect to the two second cable actuation systems along a plane defined by the first elevation level, and the respective cables of the two first cable actuation systems are arranged substantially orthogonally to the respective cables of the two second cable actuation systems.

In some aspects, positions of the each of the first and second cable actuation systems overlap with respect to another cable actuation system of a same elevation level along a direction defined by a longitudinal axis of either cable actuation system.

In some aspects, the second elevation level is arranged above the first elevation level, and the structural frame comprises a platform separating the first level and the second level.

In some aspects, each of the first and second cable actuation systems are coupled to the platform.

In some aspects, each of the first and second cable actuation systems comprises a cable routing system, wherein the system comprises: a cable outlet, one or more cable guiding pulleys; and a cable management system configured to adjust a tension and length of the respective cable, wherein the cable outlet, one ore more cable guiding pulleys, and cable management system are configured for cable routing and management of the respective cable.

In some aspects, the plurality of cables are coupled to the cable-driven device at the first elevation level.

In some aspects, each cable routing system of the second cable actuation systems is configured to route the respective cable to the first elevation level.

In some aspects, the device further comprises a battery coupled configured to supply power to the cable-driven device.

In some aspects, the device further comprises a fan coupled configured to dissipate heat from the cable-driven device.

In some aspects, the device further comprises a connection point arranged on the structural frame for rope attachment.

In some aspects, the device further comprises one or more brushes configured to perform cleaning operations on the work surface.

In accordance with another aspect of the present disclosure, a system for performing a surface operation on a building is disclosed, the system comprising: a cable-driven device according to any one of the above aspects; and a processor configured to: automatically adjust a length of each of the plurality of cables between the body and a respective removable connection; and maintain a tension in each of the plurality of cables.

### BRIEF DESCRIPTION OF THE DRAWINGS

Further features and advantages of the present disclosure will become apparent from the following detailed description, taken in combination with the appended drawings, in which:

FIG. 1 depicts an embodiment of a cable-driven device;

FIGS. 2a and 2b depict the structure and components of the cable-driven device of FIG. 1;

FIG. 3 depicts a top view of the cable-driven device of FIG. 1 showing the components of the cable actuation system;

FIG. 4 depicts a side view of an arrangement of the actuator systems of the cable-driven device of FIG. 1;

FIG. 5 depicts an isometric view of the cable-driven device of FIG. 1 showing the arrangement of cables;

FIGS. 6a and 6b depict side views of the cable-driven device of FIG. 1 showing the cable guiding systems; and

FIG. 7 depicts another embodiment of a cable-driven device of FIG. 1 configured for surface cleaning operation.

It will be noted that throughout the appended drawings, like features are identified by like reference numerals.

### DETAILED DESCRIPTION

Cable-driven parallel robots are robotic systems that use cables to actuate a platform about a work space. The robots may be particularly useful for traversing large workspaces. These robots can either be externally actuated or internally actuated. An externally actuated cable-driven robot may be characterized by multiple cables attached to fixed points on the structure and to a moving robot platform. The cables are actuated by winches or pulley systems located outside the robot. As such, externally actuated cable-driven robot requires infrastructural setup as the robot itself would be unable to perform any operations since it does not contain any means of actuation for movement. In comparison, an internally actuated cable-driven robot can be characterized by multiple cables attached to fixed points on the structure and to a moving robot platform. The cables may be actuated, for example, by winch or pulley systems located within the robot. Such a design can increase the range of motion of the robot and better facilitate the handling of larger payloads.

Devices and systems of performing operations in a space or on a surface are provided. The device and system may be an internally actuated cable-driven robot and may comprise a multi-level structural frame with one or more cable actuator systems. For example, the device and system may comprise two levels, each level comprising one or more actuator systems. Each of the cable actuator systems may be coupled to a respective cable and may be configured to automatically adjust a length of the respective cable between a support connection and the device or system such that a tension in each respective cable is maintained to move the device or system in an area on a surface. Each of the plurality of cables may be configured to removably connect to support connections on the surface. The devices and systems can be used in smaller or restrictive spaces, or on surfaces with complex geometries or irregular surfaces to for example, perform non-destructive testing (NDT) inspections, cleaning, painting or scanning.

Each of the cable actuator systems may be coupled to a respective cable routing system configured to route the respective cables in desired directions. For example, the cables coupled to one or more actuator systems on a second level of the device or system may be routed to exit the device or system on a first level of the device or system. As used herein, a level may refer to a different elevation. For example, components of a first level may be arranged at a lower or higher elevation than components of a second level.

By arranging the one or more cable actuator systems on multiple levels, the footprint (i.e. horizontal surface area/coverage) of the device and system may be reduced. Such a modification (reduction in size) may enhance the handling of the device and improve the versatility and adaptability of the device or system. For instance, by performing operations in smaller spaces where a larger device or system would not be able to operate in. Further, the one or more cable actuator systems may be arranged on chassis, in particular a platform structure that can separate the different levels of the device or system (e.g. between the first and second level). In particular, the one or more cable actuator systems of the first level may be coupled to the platform in an inverse configuration (e.g. upside down). For example, each cable actuator system can comprise a based configured for coupling the cable actuator system to a supporting structure, frame, or chassis. In the inverse configuration, the bases can be coupled chassis, such as the platform structure. This particular arrangement may enahnce the space utilization of the systems and device by increasing the amount of space available on a base of the device of the system such that additional components, for example, batteries and a control system, may be installed in the device and system without compromising the size of the device or system.

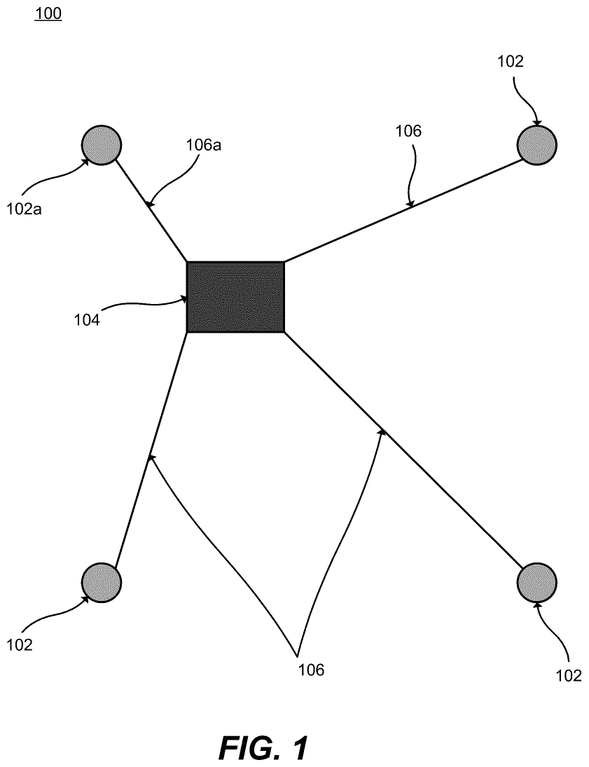

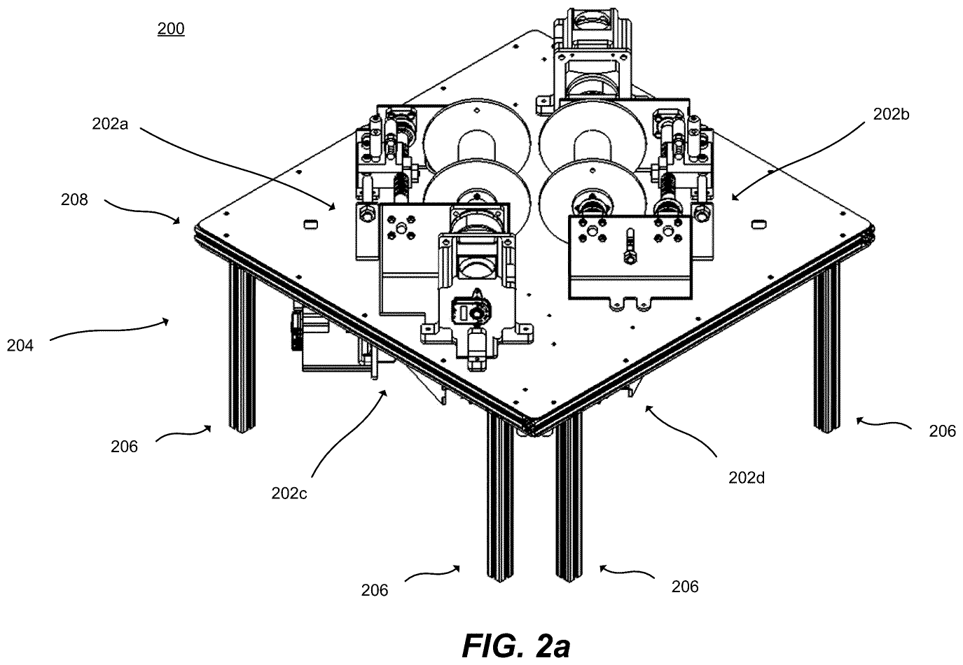

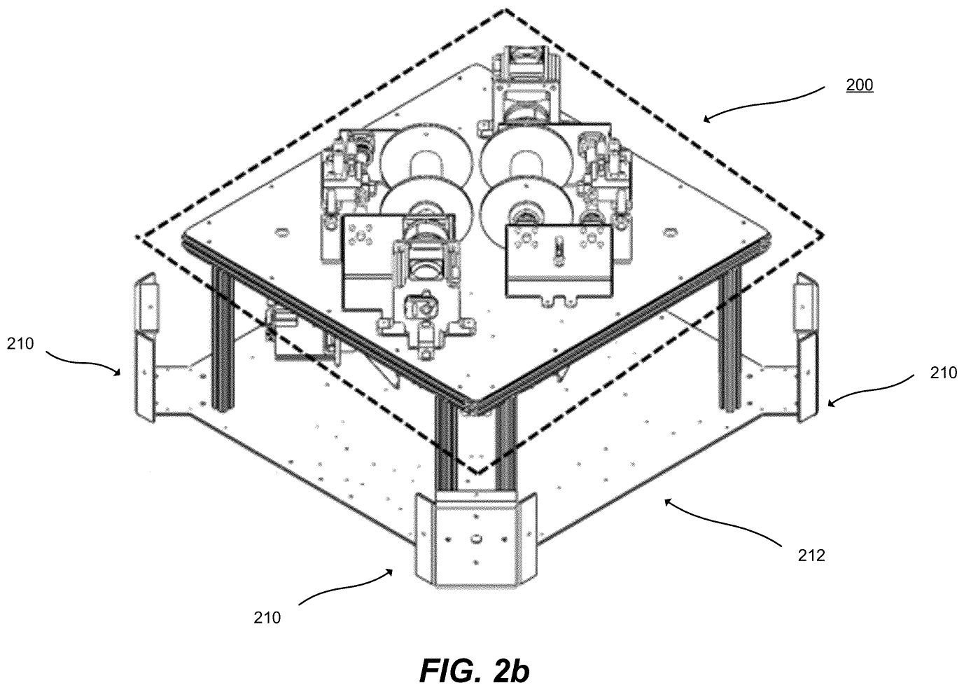

Embodiments are described below, by way of example only, with reference to FIGS. 1-7. Note that dashed lines in FIGS. 2b-7 are for illustrative purposes only and do not form a part of the device. In particular, the dashed line may highlight a section or portion of the device.

FIG. 1 depicts an embodiment of a device 100. The device 100 may be a cable-driven device which comprises a main body or end effector 104 and a plurality of cables 106 coupled to connection points 102. Each of the plurality of cables 106 is coupled to the body 104 and removably connects to the surface via the connections 102. It should be noted that the plurality of cables 106 may also be removably coupled to the main body 104.

The cable-driven device 100 may be a cable-driven parallel robot a moving platform. The cable-driven device 100 may comprise a chassis or frame structure for support which is coupled to a plurality of cables 106. The connection points 102 may be configured for connecting the cable-driven device 100 to a surface. The main body or end effector 104 can be configured or modified for performing an operation or service on the surface.

The connections points 102 may be permanent or temporary fixtures or supports such that cables 106 may be removably attached to the surface. The fixtures or supports may be fixtures specifically for the cable-driven device 100 or the fixtures may be different features already present on the surface or in the space. The fixtures may be positioned or chosen by a user at (or as) particular points on the surface or in the space so that the main body 104 can perform a service on the area between the fixtures. For example, the connection points 102 may be anchor points on a surface. As depicted in FIG. 1, there may be four fixtures and therefore four connections points 102 to connect to. It will be appreciated that there may be more or less fixtures that the device 100 connects to depending on the numbers of cables 106 and connections 102. The cable-driven device 100 can be configured to adjust the length of each of the cables 106, between the connection points 102 and the main body 104, so that the main body 104 can be moved within the area between the fixtures and perform the service on the area. For example, if a length of one of the cables 106a is shortened, the body 104 is moved closer to the connection 102a, to which the cable 106a is coupled to. It will be appreciated that as the length of one of the cables, for example cable 106a, is shortened, the lengths of the remaining cables may be adjusted accordingly, to maintain tension in the cables.

Although four connections points or fixtures are depicted, it will be appreciated that there may be more or less connection points or fixtures and cables on the device to allow for more accurate services to be performed by the device 100, depending on the application and services being performed by the device 100. Further, there may be fixtures placed on other surfaces. Similarly, although four cables 106 are depicted, it would be appreciated that more or less cables 106 are also possible, depending on the configuration of the device 100 and/or the application and services being performed by the device 100. Moreover, although FIG. 1 depicts that each connection point 102 is coupled to a respective cable 106, it would be appreciated that multiple cables may be removably coupled to the same connection point 102.

The length and/or tension of each cable 106 may be adjusted by one or more cable actuation systems. The cable actuation systems may be arranged inside of the main body 104, as described further herein. The cable actuation systems may each comprise one or more winches or pulleys for actuating the main body 104. According to a particular embodiment of the present disclosure, each cable actuation system may comprise motor drivers for actuating motors. The motors may be configured to move one or more spindles/spools such that the lengths of each of the cables 106 may be shortened or lengthened. As used herein, a motor in combination with a spindle or spool is referred to as a winch. Each cable's length may adjusted by a corresponding winch. It should be noted that the cable actuation system may additionally or alternatively use one or more pulleys with or in place of the winch. The winches or pulleys may be configured to adjust a length of each cable by shortening or lengthening each of the plurality of cables such that the body 104 is moved closer to or farther from particular connections 102 while maintaining tension in the cables. In some embodiments of the present disclosure, the connection points 102 may comprises winches or pulleys additional to or as substitutes to winches or pulleys inside the main body 104. Further, It will be appreciated that instead of a spindle/spool or winch, the device may comprise another mechanism for adjusting the length of the cables. In some embodiments, one or more of the connection points 102 may alternatively or additionally comprise, for each connection point, at least one pulley or winch for adjusting the length of the corresponding cable.

The main body 104 of the device 100 may also comprise a control PC and power supply (not depicted). The control PC may be a microcontroller 308 that is configured to send control signals to the one or more motor drivers such that the motors are actuated to adjust the length and/or tension of the cables 106. Power to the device 100 may be internally supplied through a battery, or externally supplied through a power cable. In embodiments where the power is supplied through a power cable, the weight of the cable-driven device may be reduced. It will be appreciated that the internal-actuation configuration of the cable-driven device 100 may increase the weight of the device, which may make the device more suitable for smaller payloads. It will be further appreciated that this allows for the device 100 to be used where there is very limited space to setup, or when flexibility over the space is required.

The control PC can comprise a CPU 110, a non-transitory computer-readable memory, a non-volatile storage, an input/output interface, and graphical processing units (“GPU”). The non-transitory computer-readable memory comprises computer-executable instructions stored thereon at runtime which, when executed by the CPU, configure the device 100 (e.g. the motor drives) to adjust the length and/or tension in the cables. The non-volatile storage has stored on it computer-executable instructions that are loaded into the non-transitory computer-readable memory at runtime. The input/output interface allows the server to communicate with one or more external devices such a external control device. The GPU may be used to control a display for interacting with a user (e.g. via the external control device). The CPU and the GPU can also be used to process data in order to automatically adjust the length and/or tension in the cables. The device 100 may provide a communications interface which allows software and data to be transferred, for example between the external control device and the device 100 over a communications network (e.g. the internet).

The CPU and GPU may be one or more processors or microprocessors, which are examples of suitable processing units, which may additional or alternatively comprise an artificial intelligence accelerator, programmable logic controller, a microcontroller (which comprises both a processing unit and a non-transitory computer readable medium), Al accelerator, neural processing unit (NPU), or system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

As described above, the device 100 may be controlled by maintaining tension of the plurality of cables and actuating the cable actuation systems in a coordinated manner to move the robot around in space. In particular, it may be possible to first model the dynamic and kinematic properties of the device 100, then develop a (feedback) control algorithm that can utilize one or more internal sensors (not shown in FIG. 1) (e.g., rotary encoders and force gauge sensors) to estimate the tension and the length of the cables. According to a further embodiment, a motion command in 3D space can be transferred into the corresponding actuator command inputs that will be executed and monitored by the PC controller of the device 100.

If the surface or space for the service is large, the surface or space may be divided into multiple areas for the service or operation, with multiple fixtures or supports for each area. For example, there may be additional fixtures above, below, or beside the fixtures depicted in FIG. 2. The cable-driven device can be moved from one area to another, connecting to the respective fixtures for the particular area each time. Note that there may be one cable driven device that is moved from area to area to perform the services or operations on the whole surface or space, or there may be multiple cable driven devices that can be used for one or more of the areas requiring service or operation.

FIGS. 2a and 2b depict isometric views of an embodiment of the device 100 including its structure and components. The device may comprise a main structural frame 200 (e.g. chassis), sometimes referred to as a bar structure, for structural support and coupling of various components. As depicted in FIG. 2a, one or more cable actuation systems 202a, 202b, 202c, and 202d may be arranged on the bar structure 200. It should be noted that while four cable actuation systems are depicted in FIG. 2a, more or less cable actuation systems are also possible, depending, for example, on the number of cables coupled to the device, the operations to be performed, as well as the size and weight limitations of the device. Each of the cable actuation systems 202a, 202b, 202c, and 202d may be coupled to a platform 208 of the bar structure 200. The bar structure 200 may also comprise one or more structural pillars 206 for structural support of the bar structure 200 and any device components attached thereto. The pillars 206 can also be configured to couple the bar structure 200 and any device components attached thereto to a base 212. The base 212 may comprise one or more cable guiding outlets 210 configured for cable management, for example, to feed the cable at a certain location or towards a certain direction (i.e. connection points). According to the embodiment of the device as depicted in FIG. 2b, there may be a cable guiding outlet 210 for each cable actuation system 202a, 202b, 202c, and 202d, which may direct the cables in the four principle directions.

Note that additional components may be coupled to the base 212. For example, one or more wheels may be attached below the base 212 to facilitate movement of the device on the work surface. Similarly, tools for performing specific surface operations may also be coupled to the bottom of the base 212. For example, one ore more brushes for performing surface cleaning. Further, additional components such as fans, batteries, and processors may be coupled to the base 212 or bar structure as required by the device at various locations as required by configuration, design, and space limitations. It should be noted that FIGS. 2a and 2B depicts an “open concept” design of the device where minimal structural components form the device. That is, only features that are required for weight bearing and component coupling are included in the device. As such, various internal components such as cable actuation systems 202a, 202b, 202c, and 202d may be exposed to the environment. Such a design can reduce a weight of the device which may be beneficial for certain operations. Further, the reduction in weight may reduce strains on the cables and cable actuation systems. Alternatively, the device may comprise structural covering as a part of or outside of the bar structure 200 and base 212 that covers at least a portion of the internal components of the device. Such a design may better protect the internal components such as cable actuation systems 202a, 202b, 202c, and 202d from the external environment, by reducing or preventing the wear and tear of weather, work surface, and other such environmental hazards.

It would be appreciated that a height of the pillars 206 may determine a height of the device and the amount of space between the base 212 and platform 208 for the installation and arrangement of various components. It should be noted that while FIG. 2a depicts two cable actuation systems 202a 202b arranged above the platform 208 and two cable actuation systems 202c 202d arranged below the platform 208, other arrangements or distribution of cable actuation systems are possible as well. Although FIGS. 2a and 2b depicts that cable actuation systems 202c 202d, arranged below the platform 208, are coupled to the platform 208, it should be noted that it is possible to couple one or more cable actuation systems to the base 212 instead of or additional to the platform 208. Further, each cable actuation system may be coupled to a respective cable. Accordingly, the device may comprise additional cable actuation systems for more precise control of the movement of the device through the use of additional cables/connection points that can fine-tune the movement of the device in a particular direction.

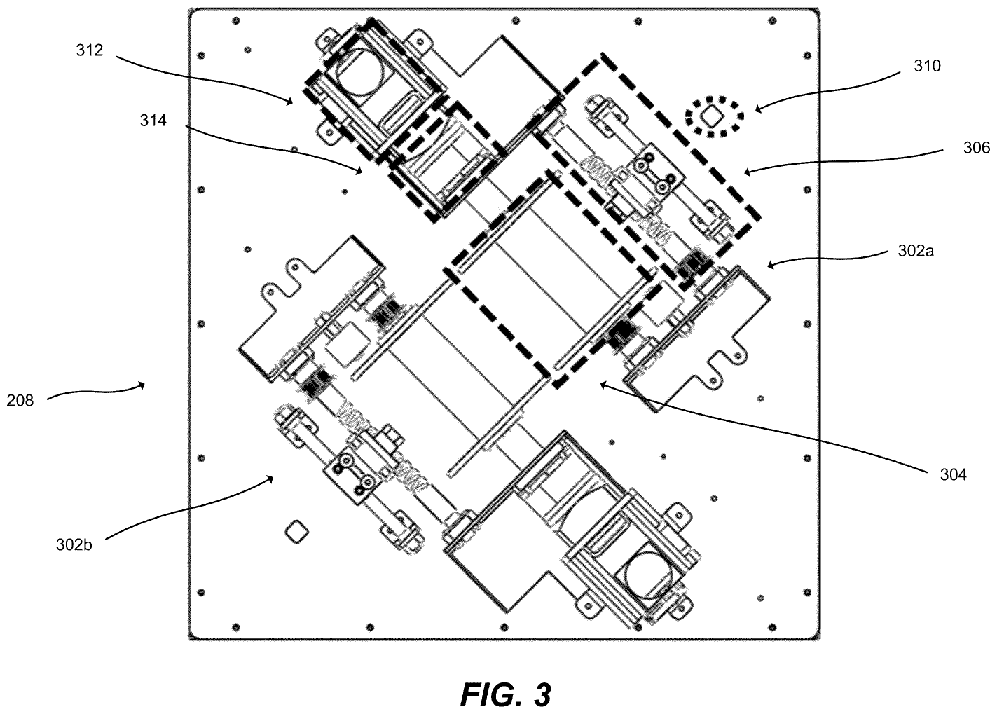

FIG. 3 depicts a top view of the bar structure of the device showing one or more cable actuation systems and their components. As depicted in FIG. 3, two cable actuation systems 302a 302b are arranged on top of the platform 208 of the bar structure. It would be appreciated that while two cable actuation systems are depicted, more or less cable actuation systems are also possible. Each of the cable actuation systems may comprise a motor 312, a gearbox 314, and a drum 304. With reference to the cable actuation system 302a, the motor 312 may be actuated to move (e.g. rotate) the drum 304. It would be appreciated that the drum 304 may also be a spindle or spool and can be configured to wind or unwind (i.e. manage the length and tension of) a respective cable (not shown) of the cable actuation system 302a. As described previously, the device may be moved in the direction of the cable by adjust the length of the cable. The gearbox 314 may be configured to control the speed (e.g. rate of rotation) and/or torque of the motor 312 to control the movement speed of the device (e.g. controlling the rate of cable lengthening/shortening) as well as to better maintain tension in the cables.

It should be noted that the one or more cable actuation systems of device (including systems below the platform 208 that are not shown in FIG. 3) may be substantially the same systems but arranged or oriented different as required by the direction of the cables or the design of the device. For example, the cable actuation systems 302a is arranged such that it is substantially oriented opposite to the cable actuation system 302b. Such an arrangement may better facilitate the control of cables from opposing directions (i.e. more optimal tension control) and additionally allow the device to have smoother movement and better weight distribution during movement. It would be appreciated that the relative orientation of the cable actuation systems may be changed slightly without impacting the operations of the device. For example, the orientation of the cable actuation system may be changed a total of 45 degrees in either direction relative to each other (for example, reorienting both systems 20 degrees clockwise results in a total reorientation of 40 degrees). In a preferably embodiment of the present disclosure, the orientation of the cable actuation systems is not altered more than 30 degrees relative to each other. Further note that the at least a portion of the cable actuation systems 302a 302b may be arranged along side of each other. For example, the longitudinal sides of cable actuation systems 302a 302b are arranged such that the two systems are substantially arranged along side one another, as depicted in FIG. 3. Although arranging the cable actuation systems in a line is also possible, by arranging the systems along side each other, it is possible to reduce the required space/size (i.e. footprint) of the device such that the design is more compact. Further, it can ben seen that the cable actuation systems 302a 302b are arranged orthogonally or substantially orthogonally to the diagonal axis of the platform 208. Although other orientation is possible (for example, aligning the longitudinal sides of the cable actuation systems with the sides of the platform 208), this arrangement can also help reduce the footprint of the device as well as better facilitate better cable management (i.e. routing of cable below the platform 208, described further herein). Note that the description of orientation relative to the platform is particular to devices or platform that are substantially rectangular in shape.

Note that the cable actuation systems may be analogous to one another, for example identical, or substantially/functionally the same (also applies for cable actuation systems arranged below the platform 208). Moreover, the logic regarding the orientations of the cable actuation systems as described above similarly applies for the cable actuation systems arranged below the platform 208.

According to some embodiments of the present disclosure, the cable actuation systems 302a 302b may be coupled to a respective cable management system 306. The cable management system 306 may comprise at least a winding and guiding mechanism, such as pulleys, configured to guide the cable in a desired direction along a desired path. As depicted in FIG. 3. with regard to cable actuation system 302a, the cable management system 306 may route the cable from cable actuation system 302a (i.e. drum 304) through one or more cable slots 310 on the platform 208 that is open to the space below platform 208 such that the cable exits the device below platform 208. This arrangement may ensure better contact of the device with the work surface as well as consistent tension between various cables coupled to cable actuation systems arranged at different positions (e.g. above and below the platform 208).

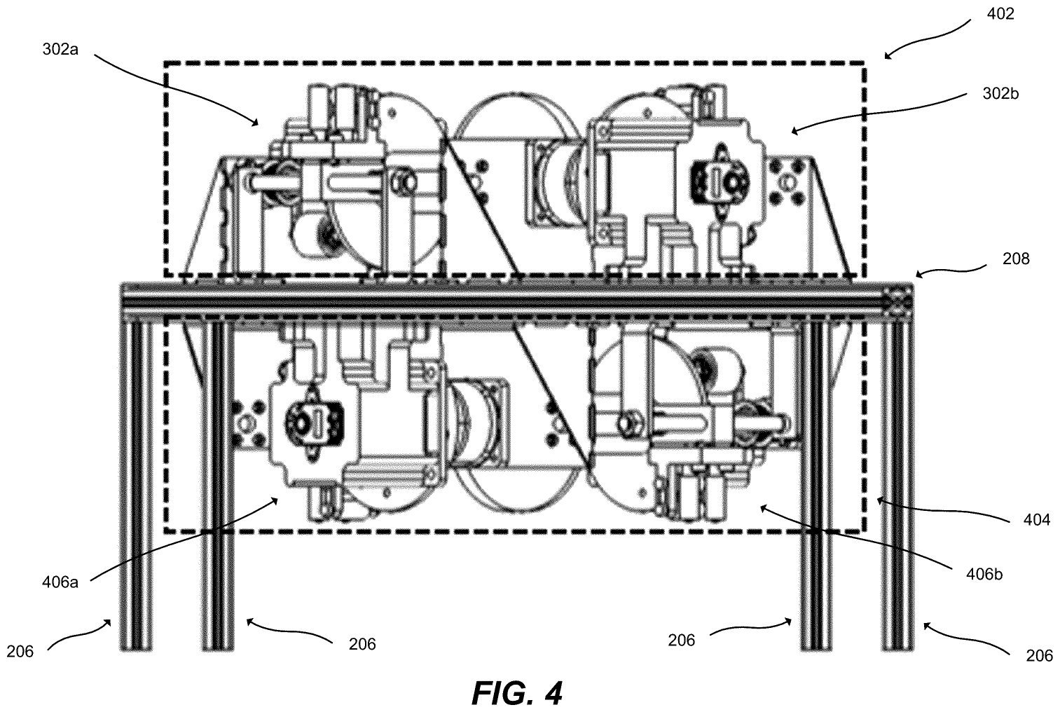

FIG. 4. depicts a side view of the bar structure and cable actuation systems of the cable-driven device according to an embodiment of the present disclosure. As depicted in FIG. 4, the bar structure may comprise a platform 208 and one or more structural pillars 206 for structural support and coupling of the bar structure to the base (not shown). One or more cable actuation systems 302a and 302b may be arranged above the platform 208. One or more cable actuation systems 406a and 406b may by arranged below the platform 208. The device may comprise multiple levels. A level may refer to a volume of space containing one or more components that is arranged at substantially the same vertical height. A level can also refer to a particular elevation level. That is, components of the device arranged at different vertical heights may be considered as being arranged in different (elevation) levels. In particular, FIG. 4 depicts a device with a two-level design. A first or lower level 404 may refer to the part of the device that is situated below the platform 208 (and for example, above the base or work surface). As such, the one or more cable actuation systems 406a and 406b arranged below the platform 208 may also be referred to as first level or lower level cable actuation systems. Similarly, a second or upper level 402 may refer to the part of the device that is situated above the platform 208. That is, the platform 208 marks the boundary between the first level 402 and second level 404 (i.e. separates the two levels). Accordingly, the one or more cable actuation systems 302a and 302b arranged above the platform 208 may also be referred to as second level or upper level cable actuation systems. As described previously, the first level and second level cable actuation systems 302a 302b 406a 406b may be analogous to one another. By arranging the one or more cable actuation systems in multiple different levels (e.g. the first level 402 and second level 404), the number of device component is each level is reduced. Therefore, as not every device component are arranged in one level, the footprint (i.e. length and width) of the device can be reduced to accommodate certain device operations and/or operations in more limited spaces. Note that additions of further cable actuation systems can be achieved through the additions of further levels as to not increase the device footprint.

According to a further embodiment of the present disclosure, the first level cable actuation systems 406a 406b may be coupled to the bar structure. In particular, the first level cable actuation systems 406a 406b may be attached or coupled to the bottom of the platform 208. For example, the bases of the first level cable actuation systems 406a 406b may be bolted and/or welded to the bottom of the platform 208 (i.e. attached in an inverted configuration), as depicted in FIG. 4. Such an arrangement may further reduce the footprint of the device and improve the arrangement of device components. More specifically, by coupling the firs level cable actuation systems 406a 406b, which may take up considerable space, to the bar structure (instead of the base), more space is made available for the coupling of other components (such as battery and control PC) to the base. As such, the accommodation of different device components can be better arranged to reduce both the size and footprint of the device for a more compact device.

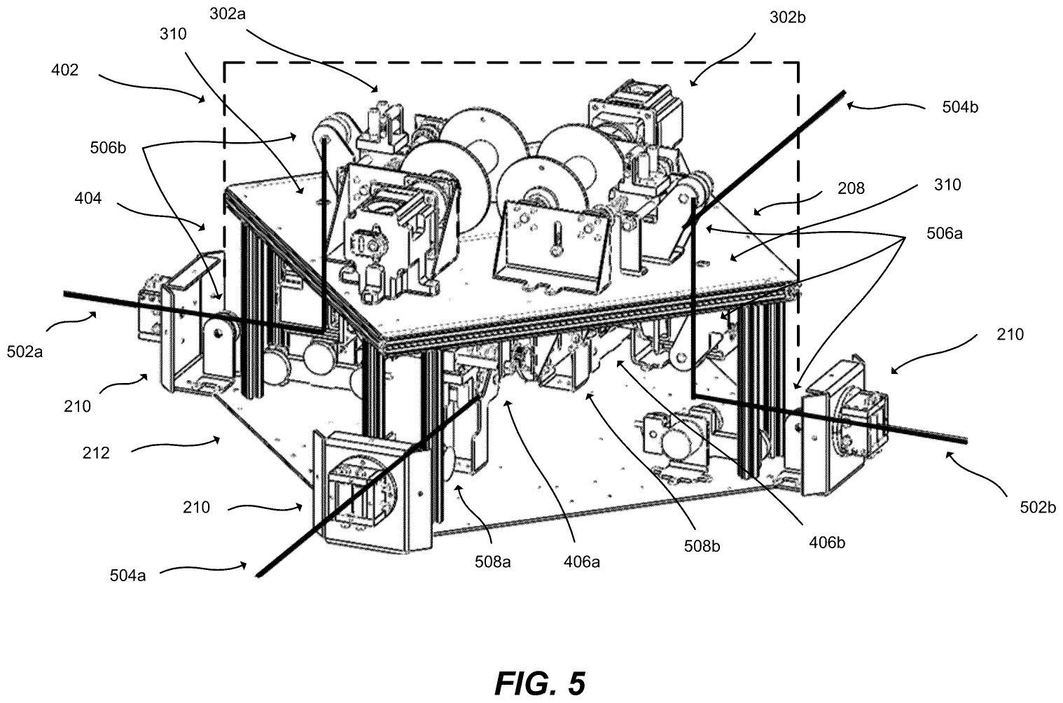

FIG. 5 depicts an isometric view of a embodiment of the cable-driven device showing the arrangement of cable actuation systems and the routing of the cables. As described previously and shown in FIG. 5, the device may comprise a main structural frame comprising a platform 208 and one or more structural pillars 206. The main structural frame may be coupled to a base 212 of the device via the one or more structural pillars 206. One or more cable actuating systems may be arranged above the platform 208 in a second or upper level 402. For example, there may be two upper level cable actuation systems 302a and 302b, as depicted in FIG. 5. One or more cable actuating systems may be arranged below and additionally coupled to the main structural frame at the platform 208 in a first or lower level 404. For example, there may be two lower level cable actuation systems 406a and 406b, as depicted in FIG. 5. Each of the cable actuation system 302a 302b 406a 406b is configured to adjust a length of a corresponding cable, depicted in FIGS. 5 as 502a, 502b, 504c, and 504d, respectively.

The cable driven-device may additionally comprise one or more cable management systems coupled to a respective cable actuation system. As depicted in FIG. 5, the lower level cable actuation systems 406a 406b are respectively coupled to lower level (first level) cable management systems 508a and 508b for managing and guiding, respectively, cables 504a and 504b. Similarly, the upper level cable actuation systems 302a and 302b are respectively coupled to upper level (second level) cable management systems 506a and 506b for managing, respectively, cables 502a and 502b. Each of the lower and upper level cable management systems may be substantially the same as one another. Alternatively, as depicted in FIG. 5, the lower cable management systems 504a 504b may be different from upper level cable management systems 502a 502b, as determined by the configuration of device components (for example, the arrangement and position of the cable actuation systems). Each of the cable management system may comprise one or more cable tensioning and routing mechanisms for cable management to direct the cable along a desired path to exit the device at a respective cable outlet 210 while ensuring that the cable is properly tensioned and straight. The cable tensioning and routing mechanisms may be installed at various locations of the device as required by the available space and desired cable path. In particular, the lower level cable management systems 508a 508b may be comprises one or more pulley systems configured to respectively route cables 504a 504b from lower level cable actuation systems 406a 406b to exit the device at one of cable outlet 210 for coupling to corresponding connection points. In comparison, the upper level cable management systems may comprise one or more pulley systems to respectively route cables 502a 502b from upper level cable actuation systems 302a 302b to exit the device at one of cable outlet 210 by first directing the cables to the lower level 404 through a respective cable slot 310 on the platform 208 before aligning the cables with the corresponding cable outlet 210. While it is possible to route the cables 502a 502b to exit the device on the upper level 402, it is possible to ensure better contact of the device with the work surface as well as consistent tension between various cables in cases where the each of the cables are routed to exit the device at the lower level 404.

It should be noted that the cable actuation systems of the same level are substantially oriented in opposite directions as to direct the cables in/to/from opposing directions. For example, upper level cable actuations systems 302a 302b and accordingly cables 502a 502b are oriented in opposing directions. Similarly, lower level cable actuations systems 406a 406b and accordingly cables 504a 504b are oriented in opposing directions. Further, the upper level cable actuations systems 302a 302b may be arranged substantially orthogonally to the lower level cable actuation systems 406a 406b on the plane defined by the platform 208. That is, in a device comprising four cable actuation systems (and four corresponding cables), each cable may point/direct to one of the principle directions on a plane defined by the base of the device (i.e. +x, −x, +y, and −y). For example, the orientation of the upper and lower cable actuation system may be changed a total of 45 degrees in either direction relative to the cable actuation systems on a different level (for example, reorienting both the upper and lower cable actuation systems 20 degrees clockwise results in a total reorientation of 40 degrees). In a preferred embodiment of the present disclosure, the orientation of the upper and lower cable actuation systems is not altered more than 30 degrees relative to each other. This distribution of cable and cable actuation systems may improve the weight distribution of the device and improve the ease of maintaining tension as well as the control/movement of the device.

As depicted in FIG. 5, the cables 502a-d may exit the device at 4 principle directions, for example substantially orthogonal horizontally from each of its nearest neighbors. This even distribution of cables can better facilitate the movement of the device. Accordingly, the upper level cable actuation systems 302a 302b may be arranged substantially orthogonally to the lower level cable actuation systems 406a 406b to ensure that the arrangement of the cables are suitable to facilitate device movement. It should also be noted that while each cable actuation system is shown as being configured to control a respective cable, a single cable actuation system may also be configured to control more than one cables. For example, both (e.g. all) cables of a particular level can be controlled using a single cable actuation system.

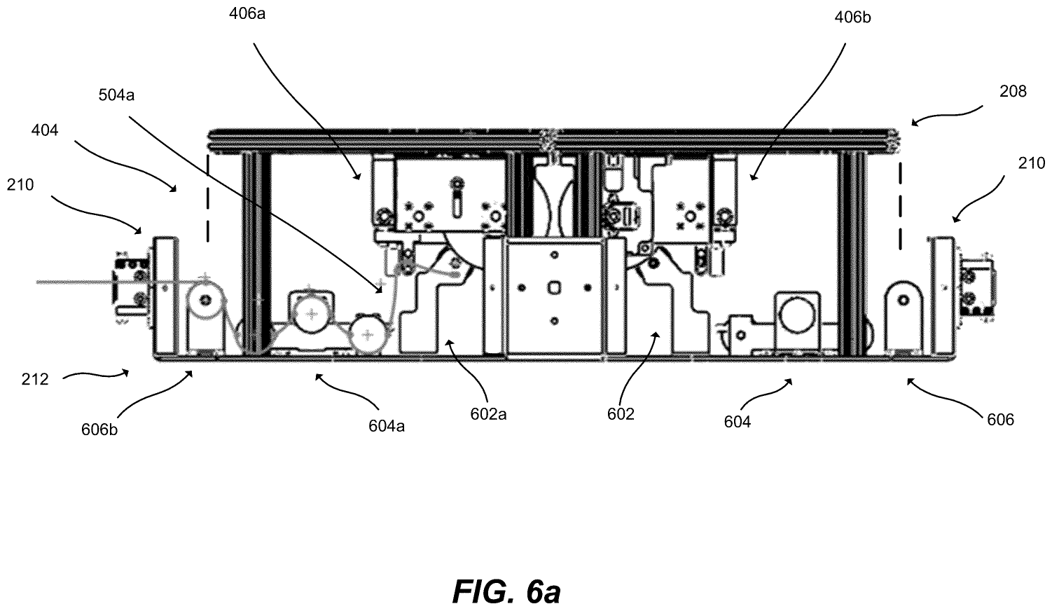

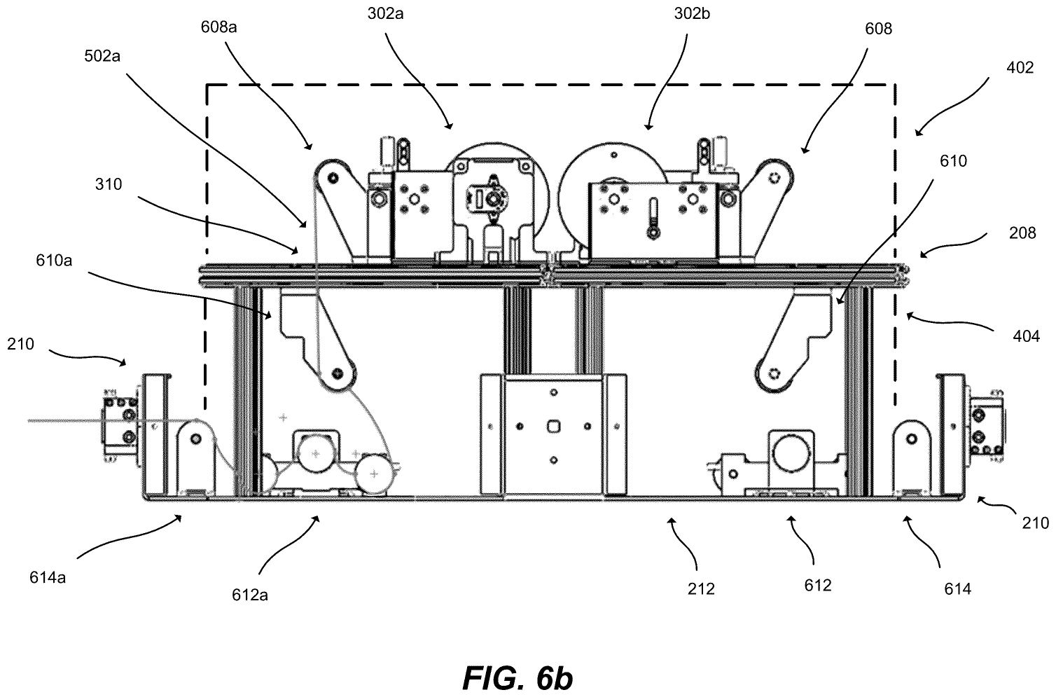

FIGS. 6a and 6b depicts a side view of the cable management systems of an embedment of the cable-driven device in which FIG. 6a depicts a side view of the lower level of the device showing the lower level cable management systems and FIG. 6b depicts a side view of the upper level of the device showing the upper level cable management systems.

As depicted in FIG. 6a, the lower level cable actuation systems 406a 406b are arranged in a first level 404 of the device and coupled to the bar structure of the device at the platform 208. Each lower level cable actuation system may be coupled to a respective lower level cable management system for managing and guiding a respective cable. The lower level cable management systems may comprise a first cable guiding mechanism 602, a measurement system 604, and a second cable guiding mechanism 606. The measurement system 604 may be configured to conduct length and tension measurements for the cable, for example, to maintain cable tension. The measurement data may be transmitted to the PC controller to operate the device. Referring particularly to cable actuation system 406a, the cable 504a is directed from the cable actuation system 406a (e.g. the drum) to the measurement system 604a by means of the first cable guiding mechanism 602a. The cable 504a then exits the measurement system 604a and is directed to exit the device at a corresponding guiding outlet 210 by means of the second cable guiding mechanism 606a. Note that one or more of the cable guiding mechanisms may be, for example, pulleys. Further, while FIG. 6a depicts the measurement system 604 and second cable guiding mechanism 602 as coupled to the base 212 and first cable guiding mechanism as coupled to the cable actuation system, other arrangements and placements of these components are also possible, based on the desired path of the cable and the availability of space.

As depicted in FIG. 6b, the upper level cable actuation systems 302a 302b are arranged in a second level 402 of the device and coupled to the bar structure of the device above the platform 208. Similar to the lower level cable actuation systems, each upper level cable actuation system may be coupled to a respective upper level cable management system for managing and guiding a respective cable. The upper level cable management systems may comprise a first cable guiding mechanism 608, a second cable guiding mechanism 610, a measurement system 612, and a third cable guiding mechanism 614. The measurement system 612 may be configured to conduct length and tension measurements for the cable, for example, to maintain cable tension. The measurement data may be transmitted to the PC controller to operate the device. Referring particularly to cable actuation system 302a, the cable 502a is guided from the cable actuation system 306a (e.g. the drum) to the first level 404 of the device from the second level 402 through the cable slot 310 with the first cable guiding mechanism 608a and second cable guiding mechanism 610a. The first and second cable guiding mechanism may also be arranged such that the cable does not come into contact with the platform 208 as it travels through the cable slot 310 to reduce wear and tear as well as prevent unexpected tension. The first and/or second cable guiding mechanism also guides the cable 502a to the measurement system 612a. The cable 502a then exits the measurement system 612a and is directed to exit the device at a corresponding guiding outlet 210 by means of the third cable guiding mechanism 614a. Note that one or more of the cable guiding mechanisms may be, for example, pulleys. Further, while FIG. 6b depicts that the first and second cable guiding mechanisms 608 610 as coupled to the platform 208 and measurement system 604 and second cable guiding mechanism 602 as coupled to the base 212, other arrangements and placements of these components are also possible, based on the desired path of the cable and the availability of space.

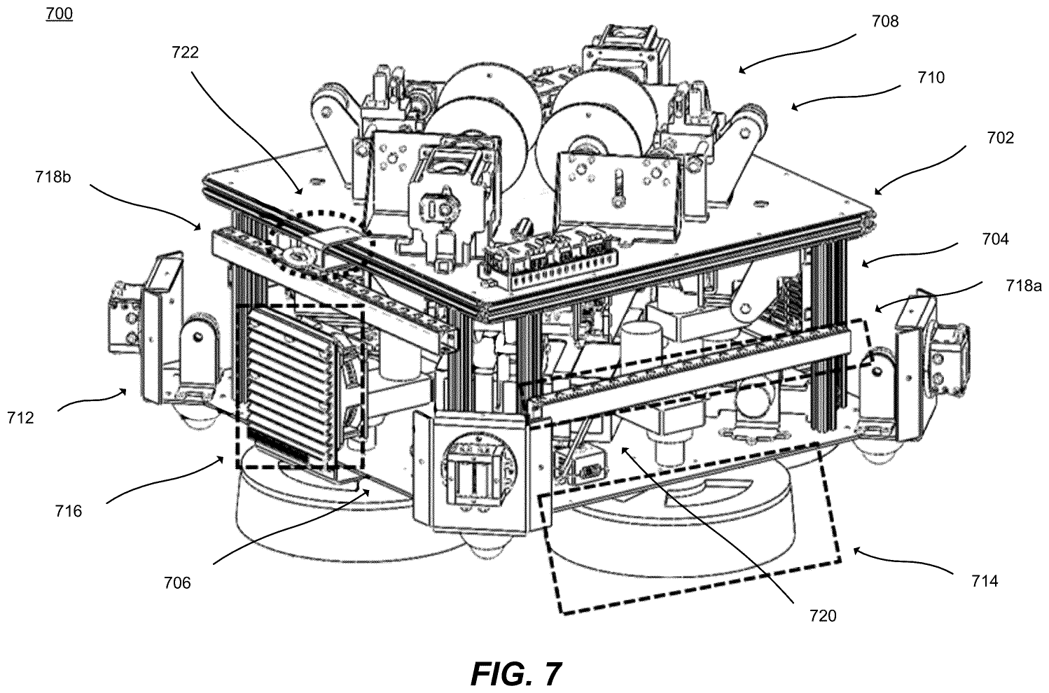

FIG. 7 depicts an embodiment of a cable-driven device with various modifications. The cable-driven device 700 may be configured for surface cleaning operations and comprises a main structural frame. The structural frame may be coupled to a base 706 and consists of a platform 702 and one or more structural pillars 704. One or more cable actuation systems 708 may be arranged in the device above and below the platform 702. Each of the one or more cable actuation systems 708 may be coupled to a respective cable management system 710 configured to manage and direct the cable, which exits the device through a corresponding cable outlet 712.

The device 700 may also comprise one or more brushes 714 for performing cleaning operations on a work surface. The one or more brushes 714 may be coupled to the bottom of the base 706. The device 700 may also comprise one or more fans 716 coupled to the structural frame or base 706. The fans 716 may be configured for thermal management of the device (i.e. heat dissipation and cooling). The fans 716 may be coupled to one or more sensors and/or a PC controller to receive temperature data and control fan operation. The device 700 may further comprise one or more wire ducts 718a 718b for managing and organizing various (electrical) wires configured for signal and power transfer. The device 700 can also comprise a battery 720 configured to power the device and individual device components. Additionally, the device 700 may comprise an eye-bolt 722 as a pivotal safety feature. The eye-bolt 722 may be configured for the attachment and coupling of a safety rope for securing the device.

In some embodiments, the main body of the device may comprise sensors. The sensors and system of the device may be configured to measure and report humidity readings, wind speed and direction, and the cable tension before, during, and/or after the service or operation. For some applications, the sensors and system may be further configured to measure the force of the body or attachment on the surface. There may be one or more sensors on the main body 204 to provide readings, measurements and/or images for the humidity readings, wind speed and direction, the cable tension, and/or other factors.

As described above, the main body of the device may comprise an attachment or end effector for performing the particular service or operation on the surface or in the space. For example, the attachment may perform non-destructive testing (NDT) inspection, cleaning, painting, scanning, coating, wiping, or other operations for the area. An attachment or end-effector may be a sensor, gripper, scanner, camera, or other attachment for providing a service. A painting attachment may comprise paint brushes or rolls for contacting a surface. A coating attachment may coat a surface with, for example a hydrophobic coating.

The disclosed device and system can be used to provide a surface processing service to the area. The cable-driven device may be light-weight and allow for an easy to set up with the connections removably connecting to fixtures or supports. The device may be able to lift high payloads and perform the service or operation over small and large workspaces. The end-effector may be tailored to the service required. In addition, it will be appreciated that the device and system may be used for other applications such as: rehabilitation aid, 3D printing, or filming.

The cables may be formed of Zylon™ or Dyneema™ which have high breaking loads, or may be formed of another material such as carbon or steel with lower breaking loads. The material and lengths of the cables are selected to prevent any breakage of the cables under tension by the winches and under the force of gravity. For some applications of the cable driven device, there may be a safety line connecting the body to a surface. The control system may comprise an emergency stop button for a user to stop the system if needed.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps or integers are included. The terms are not to be interpreted to exclude the presence of other features, steps or components. Further, as used herein, the term “comprising” can mean “including.” Variations of the word “comprising”, such as “comprise” and “comprises,” have correspondingly varied meanings. Thus, for example, a composition “comprising” X may consist exclusively of X or may include one or more additional unrecited components. It will be understood that in embodiments which comprise or may comprise a specified feature or variable or parameter, alternative embodiments may consist, or consist essentially of such features, or variables or parameters. A reference to an element by the indefinite article “a” does not exclude the possibility that more than one of the elements is present, unless the context clearly requires that there be one and only one of the elements.

Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

The terms are not to be interpreted to exclude the presence of other features, steps or components. Further, the singular forms “a”, “an”, and “the” are intended to include the plural forms as well, unless the context clearly indicates otherwise.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present. Further, in this disclosure, the term “or” is generally employed in its sense including “and/or” unless the content clearly dictates otherwise.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied herein disclosed may be resorted to by those skilled in the art, and that such modifications and variations are considered to be within the scope of this invention.

1. A cable-driven device comprising:
a structural frame;
one or more cable actuation systems arranged on a first elevation level of the structural frame;
one or more cable actuation systems arranged on a second elevation level of the structural frame;
wherein each of the first and second cable-actuation system is configured to be coupled to a respective cable, and wherein the respective cable is configured to be removably connected to different positions on a work surface.

2. The cable-driven device of claim 1, further comprising:
a plurality of cables, each of the plurality of cables respectively coupled to one of the one or more cable actuation systems.

3. The cable-driven device of claim 1, wherein a length between each of the one or more cable actuation systems and a connection point of each respective cable is automatically adjustable and a tension in each respective cable is maintained to move the cable-driven device on the surface.

4. The cable-driven device of claim 1, wherein the one or more cable-actuation systems are configured to automatically adjust a length of each respective cable between the body and a respective connection point.

5. The cable-driven device of claim 1, further comprising:
a cleaning attachment in contact with the work surface to clean the work surface.

6. The cable-driven device of claim 1, further comprising circuitry configured to:
automatically adjust the length between the respective cables and the cable-driven device to move the cable-driven device on the work surface; and
maintain the tension in the respective cables to maintain contact of the cable-driven device on the work surface.

7. The cable-driven device of claim 2,
wherein the one or more cable actuation systems is a plurality of cable actuation systems, and
wherein the cable-drive device comprises two first cable actuation systems arranged on the first elevation level and two second cable actuation systems arranged on the second elevation level.

8. The cable-driven device of claim 7,
wherein the each of the two first and second cable actuation systems is oriented between 150° to 210° with respect to another cable actuation system of a same elevation level and configured to receive cables from substantially opposing directions.

9. The cable-driven device of claim 7,
wherein the two first cable actuation systems are oriented between 60° to 120° with respect to the two second cable actuation systems along a plane defined by the first elevation level.

10. The cable-driven device of claim 7,
wherein the two first cable actuation systems are oriented substantially orthogonally with respect to the two second cable actuation systems along a plane defined by the first elevation level, and
wherein the respective cables of the two first cable actuation systems are arranged substantially orthogonally to the respective cables of the two second cable actuation systems.

11. The cable-driven device of claim 7,
wherein positions of the each of the first and second cable actuation systems overlap with respect to another cable actuation system of a same elevation level along a direction defined by a longitudinal axis of either cable actuation system.

12. The cable-driven device of claim 7,
wherein the second elevation level is arranged above the first elevation level,
wherein the structural frame comprises a platform separating the first elevation level and the second elevation level, and
wherein each of the first and second cable actuation systems are coupled to the platform.

13. The cable-driven device of claim 7,
wherein each of the first and second cable actuation systems comprises a cable routing system, the system comprising:
a cable outlet,
one or more cable guiding pulleys; and
a cable management system configured to adjust a tension and length of the respective cable,
wherein the cable outlet, one ore more cable guiding pulleys, and cable management system are configured for cable routing and management of the respective cable.

14. The cable-driven device of claim 13, wherein the plurality of cables are coupled to the cable-driven device at the first elevation level.

15. The cable-driven device of claim 14, wherein each cable routing system of the second cable actuation systems is configured to route the respective cable to the first elevation level.

16. The cable-driven device of claim 1, further comprising:
a battery coupled configured to supply power to the cable-driven device.

17. The cable-driven device of claim 1, further comprising:
a fan coupled configured to dissipate heat from the cable-driven device.

18. The device of claim 1, further comprising:
a connection point arranged on the structural frame for rope attachment.

19. The device of claim 1, further comprising:
one or more brushes configured to perform cleaning operations on the work surface.

20. A system for performing a surface operation on a building, the system comprising:
a cable-driven device comprising:
a structural frame;
one or more cable actuation systems arranged on a first elevation level of the structural frame;
one or more cable actuation systems arranged on a second elevation level of the structural frame;
wherein each of the first and second cable-actuation system is configured to be coupled to a respective cable, and wherein the respective cable is configured to be removably connected to different positions on a work surface; and
a processor configured to:
automatically adjust a length of each of the plurality of cables between the body and a respective removable connection; and
maintain a tension in each of the plurality of cables.
